(19) United States
(12) Patent Application Publication
(10) Pub. No.: US 2010/0169518 A1
(43) Pub. Date: Jul. 1, 2010

(54) Semiconductor memory device

(76) Inventors: Hyong-Yong Lee, Suwon-si (KR); Bu-Jin Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/654,749

(22) Filed: Dec. 30, 2009

(30) Foreign Application Priority Data
Dec. 31, 2008 (KR) 10-2008-0137855

(51) Int. Cl. G06F 5/14

(52) U.S. Cl. 710/53

(57) ABSTRACT

A semiconductor memory device includes a plurality of output buffer units connected to a plurality of terminals. Each of the output buffer units includes a first high speed data output (HSDO) buffer adapted to buffer even-numbered data of a corresponding data row among a plurality of data rows and to output the even-numbered data to a corresponding terminal among the plurality of terminals, a second HSDO buffer adapted to buffer odd-numbered data of the corresponding data row and to output the odd-numbered data to the corresponding terminal, and a buffer selector adapted to select and activate the first HSDO buffer and/or the second HSDO buffer in response to a corresponding control signal out of at least one control signal during a HSDO test.

### BACKGROUND

1. Field

Embodiments relate to a semiconductor memory device, and more particularly, to a semiconductor memory device capable of performing a high speed data output test.

2. Description of Related Art

Operation speeds of semiconductor memory devices are becoming faster.

However, testing devices, which, in general, are not as actively developed, have a relatively low test speed compared to the operation speed of the semiconductor memory devices.

When the test speed of the test devices does not reach the operation speed of the semiconductor memory device being tested, a high speed data output (HSDO) test is used in the test devices to test semiconductor memory devices that operate at a high speed. When a semiconductor memory device is a double data rate (DDR) memory device that outputs data twice during one clock cycle, the semiconductor memory device sequentially outputs data having a width corresponding to a half of a clock cycle during a normal operation. Assuming that a data row which is sequentially output is divided into even-numbered data and odd-numbered data, the semiconductor memory device outputs only even-numbered data or odd-numbered data during one clock cycle in the HSDO test. That is, in order to test the semiconductor memory device, the test device controls the semiconductor memory device to output one half of the amount of data output during a normal operation with a double width.

During the test, the test device stores a test pattern in the semiconductor memory device and reads data stored in the semiconductor memory device to determine whether or not the semiconductor memory device is normal. In general, a test device uses a plurality of test patterns and tests a semiconductor memory device using each of the test patterns. Since only even-numbered data or odd-numbered data of the semiconductor memory device is tested during one HSDO test as described above, the test must be performed twice for each test pattern in order to determine whether or not the semiconductor memory device is normal. Consequently, the semiconductor memory device has to be tested a number of times corresponding to twice the number of test patterns, and thus the test time is relatively lengthy.

### SUMMARY

Embodiments are therefore directed to semiconductor memory devices, which substantially overcome one or more of the problems due to the limitations and disadvantages of the related art.

It is therefore a feature of an embodiment to provide a semiconductor memory device capable of performing a high speed output test in which each of a plurality of terminals selectively outputs even-numbered data or odd-numbered data.

It is therefore another feature of an embodiment to provide a semiconductor memory device adapted to perform a high speed data output test by selectively outputting even-numbered data or odd-numbered data to each of a plurality of terminals such that each test pattern may be tested once without test coverage loss.

At least one of the above and other features and advantages may be realized by providing a semiconductor memory device coupled to a plurality of terminals, the semiconductor memory device, including a plurality of output buffer units connected to the plurality of terminals, wherein each of the output buffer units includes a first high speed data output (HSDO) buffer adapted to buffer even-numbered data of a corresponding data row among a plurality of data rows and to output the even-numbered data to a corresponding terminal among the plurality of terminals, a second HSDO buffer adapted to buffer odd-numbered data of the corresponding data row and to output the odd-numbered data to the corresponding terminal, and a buffer selector adapted to select and activate the first HSDO buffer and/or the second HSDO buffer in response to a corresponding control signal out of at least one control signal during a HSDO test.

During the HSDO test, at least one buffer selector among the buffer selectors of the plurality of output buffer units may activate the first HSDO buffer, and remaining buffer selectors may activate the second HSDO buffer.

The buffer selector may activate both the first and second HSDO buffers during a normal operation.

Each of the plurality of output buffer units may further include an output buffer adapted to buffer both the even-numbered data and the odd-numbered data of the corresponding data row and to output the even-numbered data and the odd-numbered data to the corresponding terminal.

The buffer selector may be adapted to select and activate the output buffer and inactivate the first and second HSDO buffers during a normal operation.

The semiconductor memory device may further include a memory cell array that includes a plurality of memory cells connected between a plurality of word lines and a plurality of bit lines.

The semiconductor memory device may further include a data read circuit connected to the bit lines, and adapted to detect and amplify data of the memory cells, and to output the amplified data to the output buffer units, and a controller adapted to output the at least one control signal in response to an external command.

The semiconductor memory device may further include a mode register adapted to receive and store a mode setting signal, wherein the plurality of buffer selectors are adapted to receive the mode setting signal as the control signal.

At least one of the above and other features and advantages may be separately realized by providing a semiconductor memory device including a memory cell array including a plurality of memory cells arranged along a plurality of rows, the semiconductor memory device being coupled to a plurality of terminals and including a plurality of output buffer units respectively connected to the plurality of terminals, wherein each of the output buffer units includes a first buffer adapted to buffer a first set of data of a corresponding one of a plurality of data rows and to output the first set of data to a corresponding terminal among the plurality of terminals, a second buffer adapted to buffer a second set of data of the corresponding data row and to output the second set of data to the corresponding terminal, the first set of data being different from the second set of data, and a buffer selector adapted to select and activate the first and/or the second buffer in response to a corresponding control signal.

Each of the plurality of output buffer units may further include a third output buffer adapted to buffer all data of the corresponding data row and to output all the data of the corresponding data row to the corresponding terminal.

Each of the buffer selectors may be adapted to select and activate the first buffer, the second buffer, and/or the third buffer in response to a corresponding control signal.

The first set of data and the second set of data together correspond to all data of the corresponding data row.

At least one of the above and other features and advantages may be separately realized by providing a method of testing a semiconductor memory device coupled to a plurality of terminals, the semiconductor memory device including a memory cell array including a plurality of memory cells arranged along a plurality of rows a plurality of output buffer units respectively connected to the plurality of terminals, the method including selecting and activating, for each data row of the semiconductor memory device, at least one of a first buffer and a second buffer corresponding to the respective data row, wherein the first buffer is adapted to buffer a first set of data of the corresponding one of a plurality of data rows and to output the first set of data to a corresponding terminal among the plurality of terminals, and the second buffer is adapted to buffer a second set of data of the corresponding data row and to output the second set of data to the corresponding terminal, the first set of data being different from the second set of data.

Selecting and activating may include selecting and activating, for each data row of the semiconductor memory device, at least one of a first buffer and a second buffer corresponding to the respective data row, based on a corresponding control signal supplied to a corresponding buffer selector.

During a high speed data output (HSDO) test, selecting and activating, may include selecting and activating one of the first buffer and the second buffer corresponding to the respective data row in synchronization with a rising edge of a clock signal and selecting and activating the other of the first buffer and the second buffer corresponding to the respective data row in synchronization with a falling edge of the clock signal.

During normal operation, selecting and activating may include selecting and activating both the first and second buffers.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a data output path of a semiconductor memory device according to an exemplary embodiment;

FIG. 2 illustrates a block diagram of an exemplary embodiment of an output buffer unit employable by the data output path of FIG. 1; and

FIGS. 3A to 3C illustrate exemplary timing diagrams of exemplary operations of the output buffer unit of FIG. 2.

### DETAILED DESCRIPTION

Korean Patent Application No. 10-2008-137855, filed on Dec. 31, 2008, in the Korean Intellectual Property Office, and entitled, “Semiconductor Memory Device,” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

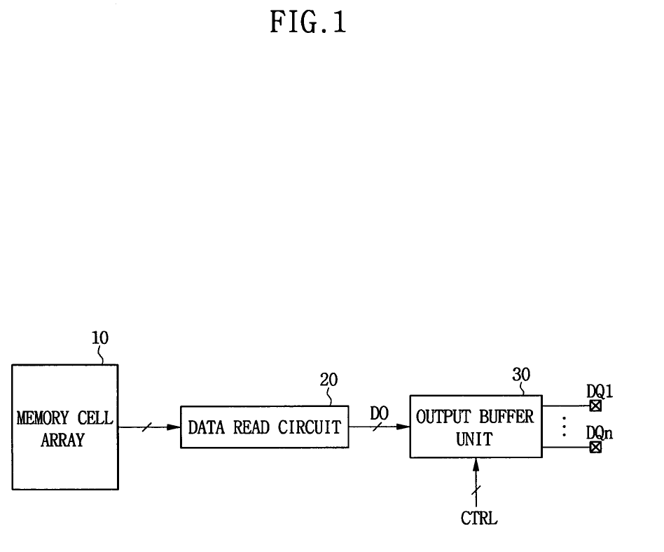

FIG. 1 illustrates a block diagram of a data output path of a semiconductor memory device according to an exemplary embodiment. The data output path of a memory device may proceed from a memory cell array 10 to terminal DQ1 to DQn via a data read circuit 20 and/or an output buffer unit 30.

Although not shown, it is understood that the memory cell array 10 may include a plurality of memory cells MC between a plurality of word lines WL and a plurality of bit lines BL. The memory cells MC may be arranged in a matrix format including a plurality of rows and columns. In response to an externally supplied address, a row decoder (not shown) may decode a row address from a plurality of addresses to activate one of the word lines WL, and a column decoder (not shown) may decode a column address to select at least one of the bit lines BL.

Data of a respective memory cell MC that is selected by the activated word line WL and the selected bit line BL may be transmitted to the data read circuit 20. The data read circuit 20 may output the data DO from respective rows of the memory cell array 10 to the output buffer unit 30. More particularly, the data read circuit 20 may detect and amplify the data of the respective memory cell MC and may output the amplified data to the output buffer unit 30.

In response to a control signal CTRL from a controller (not shown), the output buffer unit 30 may buffer both even and odd-number data, only odd-numbered data or only even-numbered data from a respective data row output from the data read circuit 20. More particularly, the output buffer unit 30 may supply corresponding output data to the terminals DQ1 to DQn, respectively.

Referring to FIG. 1, during a normal read operation, the output buffer unit 30 may buffer all data of a data row output from the data read circuit 20 to output respective data. During a high speed data output (HSDO) test, in response to the respective control signal CTRL, all terminals DQ1 to DQn may selectively output odd-numbered data or even-numbered data from a respective data row sequentially output from the data read circuit 20. In such embodiments, each of the terminals DQ1 to DQn may be configured to selectively output odd-numbered data or even-numbered data.

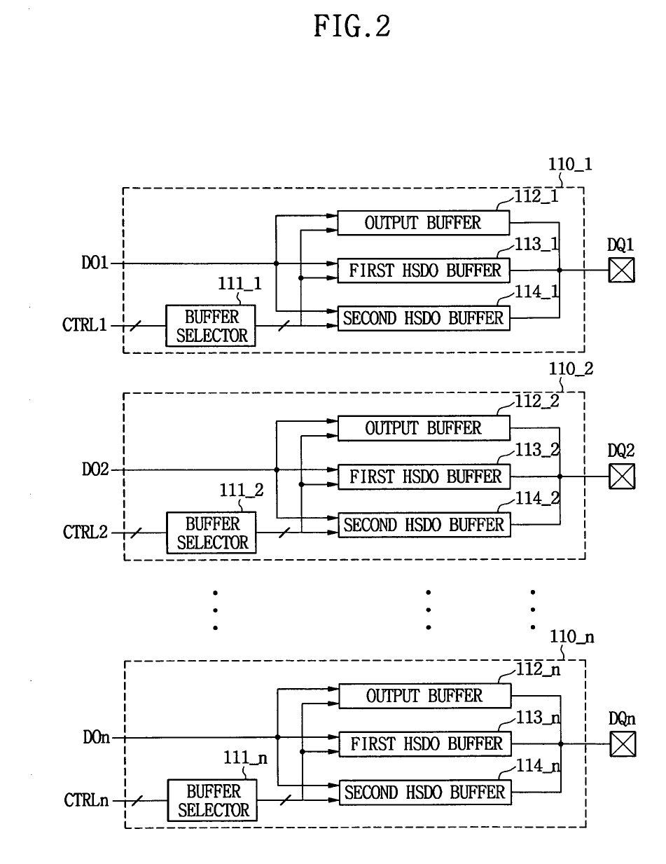

FIG. 2 illustrates a block diagram of an exemplary embodiment of the output buffer unit 30 employable by the data output path of FIG. 1.

Referring to FIG. 2, the output buffer unit 30 may receive data from the data

DO1 to DOn from the data read circuit 20. The output buffer unit 30 may include a plurality of buffer units 110_1 to 110_n that buffer the data DO1 to DOn and supply output data to a plurality of corresponding terminals DQ1 to DQn, respectively.

The buffer units 110_1 to 110_n may include buffer selectors 111_1 to 111_n, output buffers 112_1 to 112_n, first HSDO buffers 113_1 to 113_n, and second HSDO buffers 114_1 to 114_n, respectively.

The buffer selectors 111_1 to 111_n may activate or inactivate the corresponding output buffers 112_1 to 112_n, the corresponding first HSDO buffers 113_1 to 113_n, and the corresponding second HSDO buffers 114_1 to 114_n in response to control signals CTRL1 to CTRLn applied from a controller (not shown) according to an operation mode of a semiconductor memory device, respectively.

During a normal operation, the buffer selectors 111_1 to 111_n may activate the output buffers 112_1 to 112_n.

During an HSDO test mode, the buffer selectors 111_1 to 111_n may select and activate one of the first and second HSDO buffers 113_1 to 113_n and 114_1 to 114_n. During the HSDO test mode, the buffer selectors 111_1 to 111_n may individually activate the corresponding first and second HSDO buffers 113_1 to 113_n and 114_1 to 114_n, respectively. That is, since the buffer selectors 111_1 to 111_n may independently select the first and second HSDO buffers 113_1 to 113_n, the first and second HSDO buffers 113_1 to 113_n and 114_1 to 114_n may be alternately or arbitrarily selected. Alternatively, either of the first HSDO buffers 113_1 to 113_n or the second HSDO buffers 114_1 to 114_n may be selected.

During a normal operation, the output buffers 112 _1 to 112_n may be active. The output buffers 112_1 to 112_n may buffer the data DO1 to DOn output from the data read circuit 20 and may supply corresponding output data to the terminals DQ1 to DQn. During a HSDO test, the first HSDO buffers 113_1 to 113_n may be individually activated by the buffer selectors 111_1 to 111_n and may buffer even-numbered data of the row data DO1 to DOn output from the data read circuit 20 and may supply corresponding output data to the terminals DQ1 to DQn. During such an HSDO test, the second HSDO buffers 114_1 to 114_n may buffer odd-numbered data of the row data DO1 to DOn output from the data read circuit 20 and may supply corresponding output data to the terminals DQ1 to DQn.

Circuits of the output buffers 112_1 and 112_n and the first and second

HSDO buffers 113_1 to 113_n and 114_1 to 114_n may be implemented in various forms that are and would be appreciated by those of ordinary skill in the art, and thus, will not be described and/or illustrated herewith.

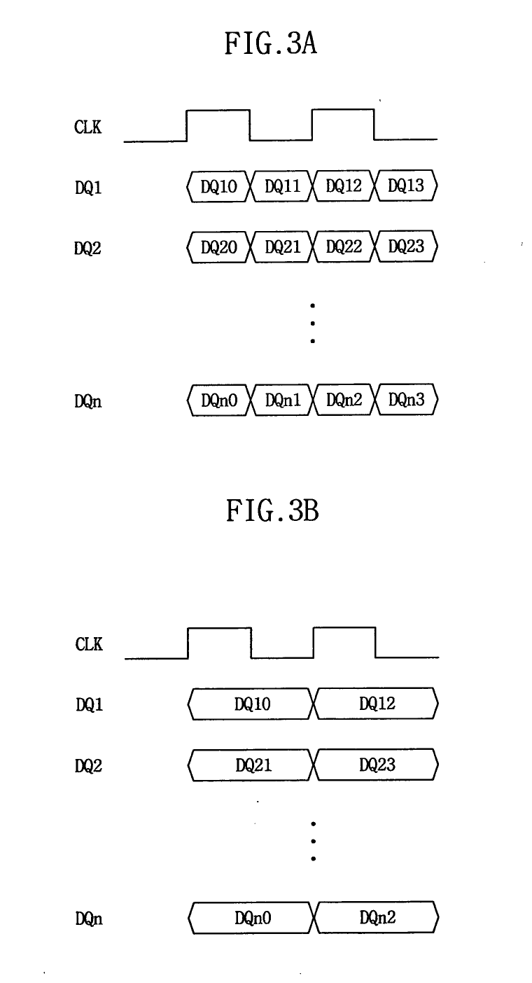

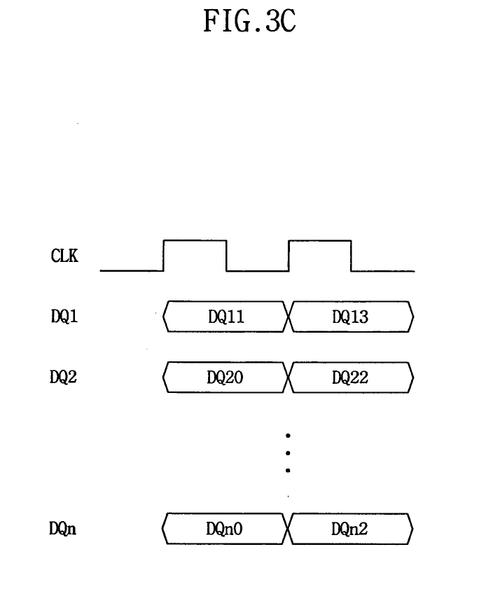

FIGS. 3A, 3B, and 3C illustrate exemplary timing diagrams of exemplary operations of the output buffer unit of FIG. 2. More particularly, FIG. 3A illustrates a timing diagram of an exemplary operation of the output buffer unit 30 of FIG. 1 during a normal operation. FIGS. 3B and 3C illustrate exemplary timing diagrams of exemplary operations of the output buffer unit 30 of FIG. 1 during a HSDO test. In the following exemplary description of FIGS. 3A to 3C, for exemplary/illustrative purposes, it is assumed that a semiconductor memory device including the output buffer unit of FIG. 2 is a double data rate (DDR) memory device, and a burst length (BL) is 4.

Referring to FIG. 3A, during a normal operation, the buffer selectors 111_1 to 111_n may select and activate all of the output buffers 112_1 to 112_n in response to the control signals CTRL1 to CTRLn, respectively. In the exemplary embodiment in which the semiconductor memory device is a DDR memory device and the burst length is 4, data rows (DQ10, DQ11, DQ12, DQ13) to (DQn0, DQn1, DQn2, DQn3) may be sequentially applied to the output buffers 112_1 to 112_n of the output buffer units 110_1 to 110_n by four bits during two cycles of a clock signal CLK, and the output buffers 112_1 to 112_n may buffer all the data rows DQ1 to DQn and supply the corresponding output data (DQ10 to DQ13) to (DQn0 to DQn3) to the terminals DQ1 to DQn, respectively. That is, e.g., since the output buffers 112_1 to 112_n may buffer and output all of applied data (DQ10 to DQ1n) to (DQn0 to DQn3), the output data (DQ10 to DQ13) to (DQn0 to DQn3) may also output by four bits during two cycles of the clock signal CLK.

Referring to FIG. 3B, as an example of a HSDO test, the buffer selector 111_1 of the output buffer unit 110_1 may select and activate the first HSDO buffer 113_1 in response to the control signal CTRL1, the buffer selector 111_2 of the output buffer unit 110_2 may select and activate the second HSDO buffer 114_2 in response to the control signal CTRL2, and the buffer selector 111_n of the output buffer unit 110_n may select and activate the first HSDO buffer 113_n in response to the control signal CTRLn. The buffer selectors 111_3 to 111_(n-1) may select and activate one of the first and second HSDO buffers 113_3 to 113_(n-1) and 1144 to 114_(n-1) in response to the control signals CTRL3 to CTRL(n-1), respectively.

The output buffer units 110_1 and 110n in which the first HSDO buffers 113_1 and 113_n are active may buffer even-numbered data (DQ10 and DQ12) and (DQn0 and DQn2) from the data rows DQ1 and DQn and may supply corresponding output data to the terminals DQ1 and DQn during two cycles of the clock signal CLK. The output buffer unit 110_2 in which the second HSDO buffer 114_2 is active may buffer odd-numbered data DQ21 and DQ23 from the data row DQ2 and may supply corresponding output data to the terminal DQ2 during two cycles of the clock signal CLK.

Referring to FIG. 3C, as another example of a HSDO test, the buffer selector 111_1 of the output buffer unit 110_1 may select and activate the second HSDO buffer 114_1 in response to the control signal CTRL1, the buffer selector 111_2 of the output buffer unit 110_2 may select and activate the first HSDO buffer 113_2 in response to the control signal CTRL2, and the buffer selector 111_n of the output buffer unit 110_n may select and activate the first HSDO buffer 113_n in response to the control signal CTRLn. The buffer selectors 111_3 to 113_(n-1) may select and activate one of the first and second HSDO buffers 113_3 to 113_(n-1) and 114_3 to 114(n-1) in response to control signals CTRL3 to CTRL(n-1), respectively.

In the exemplary embodiment illustrated in FIG. 3C, the output buffer units 110_2 and 110_n, in which the first HSDO buffers 113_2 and 113_n are active, may buffer even-numbered data (DQ20 and DQ22) and (DQn0 and DQn2) from the data rows DQ2 and DQn and may supply corresponding output data to the terminals DQ2 to DQn during two cycles of the clock signal CLK, and the output buffer unit 110_1, in which the second HSDO buffer 114_1 is active, may buffer odd-numbered data DQ11 and DQ13 from the data row DQ1 and may supply corresponding output data to the terminal DQ1 during two cycles of the clock signal CLK.

As illustrated in FIGS. 3A, during a normal operation, the output buffer units 110_1 to 110_n may buffer all of data (DQ10 to DQ13) to (DQn0 to DQn3) via the output buffers 112_10 112_n and may supply corresponding output data (DQ10 to DQ13) to (DQn0 to DQn3). Referring to FIGS. 3B and 3C, during an HSDO test, the output buffer units 110_1 to 110_n may output even-numbered data or odd-numbered data from the data rows (DQ10 to DQ13) to (DQn0 to DQn3) and may supply corresponding output data from the first and second HSDO buffers 113_1 to 113_n and 114_1 to 114_n, as selected by the buffer selectors 111_1 to 111_n, respectively. Therefore, during a HSDO test, output data corresponding to half the time of a normal operation may be output to the terminals DQ1 to DQn during two cycles of the clock signal CLK as even-numbered data or odd-numbered data may be selectively output to the respective terminals DQ1 to DQn.

Since the plurality of output buffer units 110_1 to 110_n may selectively output, e.g., even-numbered data or odd-numbered data to the terminals DQ1 to DQn, respectively, the semiconductor memory device according to an exemplary embodiment may be configured such that all of the terminals DQ1 to DQn may output only even-numbered data or only odd-number data or each of the terminals DQ1 to DQn may selectively output even-numbered data or odd-numbered data.

A test for a semiconductor memory device may include a test for peripheral circuits and/or a test for determining whether or not a memory cell MC of the memory cell array 10 is normal.

If all terminals of a semiconductor memory device only output even-numbered data or odd-numbered data, even a test for peripheral circuits may need to be performed twice for each test pattern. For example, in the case in which two types of test patterns are employed, in an attempt to reduce test time, even-numbered data may be tested for a first test pattern and odd-numbered data may be tested for a second test pattern. However, in such cases, if a test of odd-numbered data based on the first test pattern and a test of even-numbered data based on the second test pattern is completely omitted, test coverage will not be complete and still needs to be performed, e.g., for odd-numbered data based on the first test pattern and even-numbered data based on the second test pattern.

Embodiments may be advantageous by providing semiconductor memory devices in which each of the terminals DQ1 to DQn may selectively output even-numbered data or odd-numbered data, and both even-numbered data and odd-numbered data may be output based on one test for each test pattern. That is, e.g., embodiments may be advantageous by providing semiconductor memory devices in which test coverage loss may not be sacrificed, e.g., lost, even when a test is performed only once for each test pattern.

In some embodiments, e.g., as described above, the control signals CTRL1 to CTRLn may be individually applied to the plurality of buffer selectors 111_1 to 111_n. However, embodiments are not limited thereto. For example, in some embodiments, only one common control, signal may be applied to control the plurality of buffer selectors 111_1 to 111_n. In such embodiments, a buffer to be selected from among the output buffers 112_1 to 112_n and the first and second HSDO buffers 113_1 to 113_n and 114_1 to 114_n may be selected based on a state of the applied common control signal, as designated by each of the buffer selectors 111_1 to 111_n.

In some other embodiments, the plurality of buffer selectors 111_1 to 111_n may receive a test mode setting signal TMRS from a mode register (not shown), instead of the control signals CTRL1 to CTRLn, to select one of the output buffers 112_1 to 112_n and the first and second HSDO buffers 113_1 to 113_n and 114_1 to 114_n.

In the exemplary embodiment described above, the respective output buffer units 110_1 to 110_n include the output buffers 112_1 to 112_n and the first and second HSDO buffers 113_1 to 113_n and 114_1 to 114_n, however, embodiments are not limited thereto. For example, in some embodiments, the output buffers 112_1 to 112_n may be omitted, and, during a normal operation, all of the first and second HSDO buffers 113 _1 to 113_n and 114_1 to 114_n may be activated to supply all of output data to the terminals DQ1 to DQn.

Although not shown, in embodiments, the output buffers 112_1 to 112_n and/or the first and second HSDO buffers 113_1 to 113_n and 114_1 to 114_n may each receive the clock signal CLK. In such cases, e.g., the output buffers 112_1 to 112_n may receive all data of the row data DOO to DOn in synchronization with a rising edge and a falling edge of a clock signal. The first HSDO buffers 113_1 to 113_n may receive even-numbered data of the row data DO0 to DOn in synchronization with a rising edge of the clock signal CLK, and the second HSDO buffers 114_1 to 114_n may receive odd-numbered data of the row data DO0 to DOn in synchronization with a falling edge of the clock signal CLK.

Exemplary embodiments described above have been described focusing on a

DDR memory device in which a burst length is set, but two data rows may be applied to each of the output buffer units 110 to 1n0 in parallel, and, e.g., each of the first and second HSDO buffers 113_1 to 113_n and 114_1 to 114_n may receive one data row. When two data rows are applied to the output buffer units 110_1 to 110_n, they may correspond to even-numbered data and odd-numbered data, respectively. In such cases, e.g., each of the output buffer units 110_1 to 110_n may be used as a serializer.

Embodiments may provide a semiconductor memory device adapted to perform a high speed data output test by selectively outputting even-numbered data or odd-numbered data to each of a plurality of terminals such that each test pattern may be tested once without test coverage loss.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

Further, while detailed illustrative embodiments are disclosed herein, specific structural and functional details disclosed herein are merely representative for purposes of describing example embodiments. It should be understood that features described herein with respect to exemplary embodiments, however, may be embodied in many alternate forms and should not be construed as limited to only exemplary embodiments set forth herein.

Accordingly, while exemplary embodiments are capable of various modifications and alternative forms, embodiments thereof are shown by way of example in the drawings and will herein be described in detail. It should be understood, however, that there is no intent to limit exemplary embodiments to the particular forms disclosed, but on the contrary, exemplary embodiments are to cover all modifications, equivalents, and alternatives falling within the scope of the application. Like numbers refer to like elements throughout the specification.

It will be understood that, although the terms first, second, etc. and/or numerals may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A semiconductor memory device coupled to a plurality of terminals, the semiconductor memory device, comprising:
a plurality of output buffer units connected to the plurality of terminals, wherein each of the output buffer units includes:
a first high speed data output (HSDO) buffer adapted to buffer even-numbered data of a corresponding data row among a plurality of data rows and to output the even-numbered data to a corresponding terminal among the plurality of terminals;
a second HSDO buffer adapted to buffer odd-numbered data of the corresponding data row and to output the odd-numbered data to the corresponding terminal; and
a buffer selector adapted to select and activate the first HSDO buffer and/or the second HSDO buffer in response to a corresponding control signal out of at least one control signal during a HSDO test.

2. The semiconductor memory device as claimed in claim 1, wherein, during the HSDO test, at least one buffer selector among the buffer selectors of the plurality of output buffer units activates the first HSDO buffer and remaining buffer selectors activate the second HSDO buffer.

3. The semiconductor memory device as claimed in claim 1, wherein the buffer selector activates both the first and second HSDO buffers during a normal operation.

4. The semiconductor memory device as claimed in claim 1, wherein each of the plurality of output buffer units further includes an output buffer adapted to buffer both the even-numbered data and the odd-numbered data of the corresponding data row and to output the even-numbered data and the odd- numbered data to the corresponding terminal.

5. The semiconductor memory device as claimed in claim 4, wherein the buffer selector is adapted to select and activate the output buffer and inactivate the first and second HSDO buffers during a normal operation.

6. The semiconductor memory device as claimed in claim 1, further comprising:
a memory cell array that includes a plurality of memory cells connected between a plurality of word lines and a plurality of bit lines;
a data read circuit connected to the bit lines, and adapted to detect and amplify data of the memory cells, and to output the amplified data to the output buffer units; and
a controller adapted to output the at least one control signal in response to an external command.

7. The semiconductor memory device as claimed in claim 1, further comprising a mode register adapted to receive and store a mode setting signal,
wherein the plurality of buffer selectors are adapted to receive the mode setting signal as the control signal.

8. A semiconductor memory device including a memory cell array having a plurality of memory cells arranged along a plurality of rows, the semiconductor memory device being coupled to a plurality of terminals, the semiconductor memory device comprising:
a plurality of output buffer units respectively connected to the plurality of terminals, wherein each of the output buffer units includes:
a first buffer adapted to buffer a first set of data of a corresponding one of a plurality of data rows and to output the first set of data to a corresponding terminal among the plurality of terminals;
a second buffer adapted to buffer a second set of data of the corresponding data row and to output the second set of data to the corresponding terminal, the first set of data being different from the second set of data; and
a buffer selector adapted to select and activate the first and/or the second buffer in response to a corresponding control signal.

9. The semiconductor memory device as claimed in claim 8, wherein each of the plurality of output buffer units further includes a third output buffer adapted to buffer all data of the corresponding data row and to output all the data of the corresponding data row to the corresponding terminal.

10. The semiconductor device as claimed in claim 9, wherein each of the buffer selectors is adapted to select and activate the first buffer, the second buffer, and/or the third buffer in response to a corresponding control signal.

11. The semiconductor device as claimed in claim 8, wherein the first set of data and the second set of data together correspond to all data of the corresponding data row.

12. A method of testing a semiconductor memory device coupled to a plurality of terminals, the semiconductor memory device including a memory cell array including a plurality of memory cells arranged along a plurality of rows a plurality of output buffer units respectively connected to the plurality of terminals, the method comprising:
selecting and activating, for each data row of the semiconductor memory device, at least one of a first buffer and a second buffer corresponding to the respective data row,
wherein the first buffer is adapted to buffer a first set of data of the corresponding one of a plurality of data rows and to output the first set of data to a corresponding terminal among the plurality of terminals, and
the second buffer is adapted to buffer a second set of data of the corresponding data row and to output the second set of data to the corresponding terminal, the first set of data being different from the second set of data.

13. The method as claimed in claim 12, wherein selecting and activating includes selecting and activating, for each data row of the semiconductor memory device, at least one of a first buffer and a second buffer corresponding to the respective data row, based on a corresponding control signal supplied to a corresponding buffer selector.

14. The method as claimed in claim 12, wherein, during a high speed data output (HSDO) test, selecting and activating includes selecting and activating one of the first buffer and the second buffer corresponding to the respective data row in synchronization with a rising edge of a clock signal and selecting and activating the other of the first buffer and the second buffer corresponding to the respective data row in synchronization with a falling edge of the clock signal.

15. The method as claimed in claim 12, wherein, during normal operation, selecting and activating includes selecting and activating both the first and second buffers.
